(19) United States
(12) Patent Application Publication
(10) Pub. No.: US 2019/0143407 A1
(43) Pub. Date: May 16, 2019

(54) ADDITIVE MANUFACTURING APPARATUS AND ADDITIVE MANUFACTURING METHOD OF SHAPED ARTICLE

(71) Applicant: JTEKT CORPORATION, Osaka-shi (JP)

(72) Inventors: Yoshinori IMOTO, Kariya-shi (JP); Koichi SHIIBA, Nisshin-shi (JP); Takaya NAGAHAMA, Obu-shi (JP)

(73) Assignee: JTEKT CORPORATION, Osaka-shi (JP)

(21) Appl. No.: 16/185,486

(22) Filed: Nov. 9, 2018

(30) Foreign Application Priority Data
Nov. 13, 2017 (JP) 2017-217961

(51) Int. Cl. B22F 3/10; B22F 3/105; B33Y 10/00; B33Y 30/00

(52) U.S. Cl. CPC B22F 3/1017; B22F 3/1055; B22F 2003/1056; B33Y 30/00; B33Y 10/00

(57) ABSTRACT

To provide an additive manufacturing apparatus of a shaped article capable of suppressing evaporation of metal and scattering of spatters. An additive manufacturing apparatus of the shaped article includes a temporary heating device heating metal powder arranged in layers at a temperature equal to or lower than a fusing point of the metal powder to allow the metal powder to be diffusion bonded and a main heating device heating the metal powder at a temperature equal to or higher than the fusing point of the metal powder by irradiating the diffusion-bonded metal powder with a light beam to thereby form a shaped article. The temporary heating device heats a range wider than an irradiation range with the light beam by the main heating device.

### CROSS REFERENCE TO RELATED APPLICATIONS

This application claims priority based on Japanese Patent Application No. 2017-217961 filed on Nov. 13, 2017, the entire contents of which are incorporated by reference herein.

### BACKGROUND OF THE INVENTION

### Technical Field

The present invention relates to an additive manufacturing apparatus and an additive manufacturing method of a shaped article.

### Background Art

In JP2008-255488A, there is disclosed a method in which metal powder arranged in layers is irradiated with a high-energy light beam (a laser beam, an electronic beam and the like) repeatedly to produce a shaped article. Also in JP2008-255488A, generation of a metal vapor and the like at the time of sintering metal powder by irradiation with the light beam is described.

Moreover, the following is described in JP2017-25392A. In shaping by an electronic beam, metal powder in a deposited state is required to have conductivity so that the electronic beam is irradiated accurately at a predetermined position. Therefore, in a case where metal powder with no conductivity is used as a raw material, it is necessary to temporarily sinter deposited metal powder to secure conductivity before irradiation with the electronic beam.

Incidentally, when metal powder arranged in layers is irradiated with a light beam to form a shaped article, it is necessary to increase an energy density (J/m³) of the light beam for improving a relative density of the shaped article. However, a power density (W/m²) in an irradiated part (heat input quantity flowing into the irradiated part) of the metal powder is increased when the energy density of the light beam is increased. As a result, the metal may be evaporated or the spatter may be scattered. When metal powder at a fused part and a part around the fused part is scattered toward other parts due to evaporation power of metal or scattering of spatters, a fused state in the fused part becomes unstable and a density of the shaped article may be reduced. Accordingly, it is necessary to suppress the evaporation of metal and scatting of spatters even if the energy density of the light beam is increased.

Furthermore, the metal powder arranged in layers adsorbs moisture. When the power density in the irradiated part of the metal powder is increased, moisture is evaporated. The metal powder at a fused part and a part around the fused part may be scattered toward other parts due to evaporation power of moisture in the same manner as described above. Therefore, it is necessary to suppress the scattering of metal powder by suppressing the evaporation power of moisture.

### SUMMARY OF THE INVENTION

An object of the present invention is to provide an additive manufacturing apparatus and an additive manufacturing method of a shaped article capable of suppressing evaporation of metal and scattering of spatters. Another object of the present invention is to provide an additive manufacturing apparatus and an additive manufacturing method of a shaped article capable of suppressing scattering of metal powder by suppressing evaporation power of moisture.

### (1. Additive Manufacturing Apparatus of Shaped Article)

A first additive manufacturing apparatus of a shaped article according to the present invention includes a temporary heating device heating metal powder arranged in layers at a temperature equal to or lower than a fusing point of the metal powder to allow the metal powder to be diffusion bonded and a main heating device heating the metal powder at a temperature equal to or higher than the fusing point of the metal powder by irradiating the diffusion-bonded metal powder with a light beam to thereby form a shaped article. Then, the temporary heating device heats a range wider than an irradiation range with the light beam by the main heating device.

The metal powder has already been diffusion bonded by the temporary heating device before the irradiation with the light beam by the main heating device. Therefore, evaporation of metal and scattering of spatters can be suppressed at the time of irradiation with the light beam. In particular, the range in which heating is performed by the temporary heating device is wider than the irradiation range with the light beam by the main heating device. Therefore, the range in which diffusion bonding is performed includes not only a part of the metal powder to be fused by irradiation with the light beam but also a part around the fused part. Then, present inventors have found that evaporation of metal and scattering of spatters occur not only at the fused part but also at the part around the fused part. Accordingly, it is possible to suppress occurrence of evaporation of metal and scattering of spatters at the part around the fused part by widening the range in which diffusion bonding is performed by the temporary heating device. As a result, a shaped article with a desired density can be produced.

A second additive manufacturing apparatus of a shaped article according to the present invention includes a temporary heating device heating metal powder arranged in layers at a temperature equal to or lower than a fusing point of the metal powder to evaporate at least part of moisture adhering to the metal powder and a main heating device heating the metal powder at a temperature equal to or higher than the fusing point of the metal powder by irradiating the metal powder with a light beam after the heating by the temporary heating device to thereby form a shaped article.

The metal powder is heated by the temporary heating device before irradiation with the light beam by the main heating device. Then, at least part of moisture adhering to the metal powder is evaporated when the metal powder is heated. That is, the moisture has already been reduced when the light beam is irradiated by the main heating device, therefore, evaporation power due to the moisture is suppressed. When the evaporation power due to the moisture is suppressed, scattering of metal powder is suppressed at the time of irradiation with the light beam. As a result, a shaped article with a desired density can be produced.

### (2. Additive Manufacturing Method of Shaped Article)

A first additive manufacturing method of a shaped article according to the present invention includes the steps of heating metal powder arranged in layers at a temperature equal to or lower than a fusing point of the metal powder to allow the metal powder to be diffusion bonded in a temporary heating step and heating the metal powder at a temperature equal to or higher than the fusing point of the metal powder by irradiating the diffusion-bonded metal powder with a light beam to thereby form a shaped article in a main heating step. In the temporary heating step, a range wider than an irradiation range with the light beam in the main heating step is heated. The same advantages as advantages obtained by the first additive manufacturing apparatus of the shaped article can be obtained.

A second additive manufacturing method of a shaped article according to the present invention includes the steps of heating metal powder arranged in layers at a temperature equal to or lower than a fusing point of the metal powder to evaporate at least part of moisture adhering to the metal powder in a temporary heating step and heating the metal powder at a temperature equal to or higher than the fusing point of the metal powder by irradiating the metal powder with a light beam after the heating in the temporary heating step to thereby form a shaped article in a main heating step. The same advantages as advantages obtained by the second additive manufacturing apparatus of the shaped article can be obtained.

### BRIEF DESCRIPTION OF DRAWINGS

FIG. 1 is a drawing illustrating an additive manufacturing apparatus according to a first embodiment;

FIG. 2 is a flowchart showing an additive manufacturing method according to the first embodiment;

FIG. 3 is a drawing illustrating an additive manufacturing apparatus according to a second embodiment;

FIG. 4 is a plan view illustrating a state where temporary heating and main heating are performed at the same time;

FIG. 5 is a flowchart showing an additive manufacturing method according to the second embodiment;

FIG. 6 is a drawing illustrating an additive manufacturing apparatus according to a third embodiment;

FIG. 7 is a plan view illustrating a state where temporary heating is performed;

FIG. 8 is a plan view illustrating a state where main heating is performed;

FIG. 9 is a flowchart showing an additive manufacturing method according to the third embodiment;

FIG. 10 is a drawing illustrating an additive manufacturing apparatus according to a fourth embodiment;

FIG. 11 is a plan view illustrating a state where temporary heating and main heating are performed; and

FIG. 12 is a flowchart showing an additive manufacturing method according to the fourth embodiment.

### DETAILED DESCRIPTION OF INVENTION

### 1. First Embodiment

### (1-1. Additive Manufacturing Apparatus)

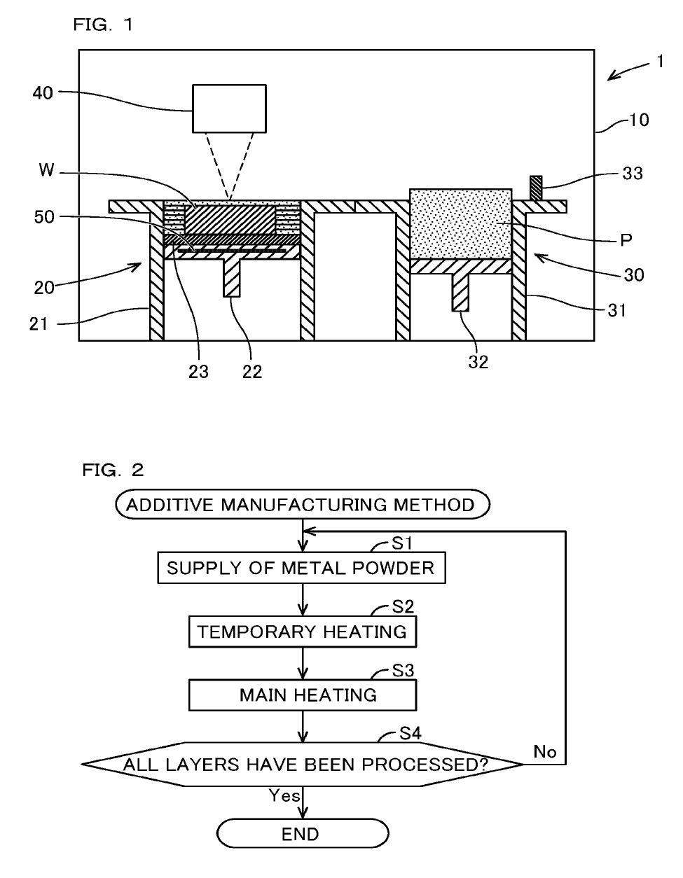

An additive manufacturing apparatus 1 of a shaped article W according to a first embodiment will be explained with reference to FIG. 1. The additive manufacturing apparatus 1 is an apparatus manufacturing a shaped article W by irradiating a metal powder P arranged in layers with a light beam repeatedly. Here, the light beam includes, for example, a laser beam, an electronic beam and other various types of beams capable of fusing the metal powder P. As the laser beam, various types of lasers such as a laser with a near-infrared wavelength, a CO2 laser and a semiconductor laser can be adopted, and the laser is appropriately determined in accordance with the metal powder P as a target. As the metal powder P, various metal materials such as aluminum, copper, maraging steel and Inconel can be adopted.

The additive manufacturing apparatus 1 includes a chamber 10, a shaped article support device 20, a powder supply device 30, a light beam irradiation device 40 (main heating device) and a temporary heating device 50 as shown in FIG. 1. The chamber 10 is formed so that inside air can be replaced by an inert gas such as He (helium), N₂ (nitrogen) or Ar (argon). The chamber 10 may be formed so as to be decompressed, not replacing the inside by the inert gas.

The shaped article support device 20 is a part provided inside the chamber 10 for shaping the shaped article W. The shaped article support device 20 includes a container for shaping 21, a lifting table 22 and a base 23. The container for shaping 21 has an opening on an upper side and an inner wall surface parallel to an axis in an upper and lower direction. The lifting table 22 is provided so as to move in the upper and lower direction along the inner wall surface in the container for shaping 21. The base 23 is attached on an upper surface of the lifting table 22 so as to be attached/detached, and an upper surface of the base 23 is a part for forming the shaped article W. That is, the base 23 is a member for disposing the metal powder Pin layers on the upper surface and supporting the shaped article W at the time of shaping.

The powder supply device 30 is provided inside the chamber 10 so as to be adjacent to the shaped article support device 20. The powder supply device 30 includes a powder storing container 31, a supply table 32 and a recoater 33. The powder storing container 31 has an opening on an upper side, and a height of the opening of the powder storing container 31 is formed to be the same as a height of the opening of the container for shaping 21. The powder storing container 31 has an inner wall surface parallel to the axis in the upper and lower direction. The supply table 32 is provided so as to move in the upper and lower direction along the inner wall surface of the powder storing container 31. Then, the metal powder P is stored in an upper region of the supply table 32 in the powder storing container 31.

The recoater 33 is provided so as to reciprocate along upper surfaces of both openings over the entire region of the opening of the container for shaping 21 and the opening of the powder storing container 31. The recoater 33 carries the metal powder P protruding from the opening of the powder storing container 31 to the container for shaping 21 side when moving from right to left in FIG. 1. The recoater 33 further arranges the carried metal powder P in layers on the upper surface of the base 23.

The light beam irradiation device (main heating device) 40 irradiates the surface of the metal powder P arranged in layers on the upper surface of the base 23 with a light beam. The light beam is the laser beam, the electronic beam or the like as described above. The light beam irradiation device 40 irradiates the metal powder P arranged in layers with the light beam, thereby heating the metal powder P to be a temperature equal to or higher than a fusing point of the metal powder P. Then, the metal powder P is fused and then solidified to thereby form an integrated shaped article.

The light beam irradiation device 40 also changes an irradiation position and an energy density in accordance with a program which is previously set. A desired shaped article can be formed by changing the irradiation position. When the energy density of the light beam is changed, the power density in the irradiated part (heat input quantity flowing into the irradiated part) of the metal powder P is changed and bonding strength among particles of the metal powder P can be changed.

The temporary heating device 50 is, for example, a heater, which is built in the lifting table 22. That is, the temporary heating device 50 heats from the lifting table 22 to the entire base 23, and heats the metal powder P arranged on the upper surface of the base 23 through the base 23. Furthermore, in a state where part of the shaped article W is formed on the upper surface of the base 23, the temporary heating device 50 heats the metal powder P through the base 23 and part of the shaped article W. The temporary heating device 50 heats the metal powder P arranged on the upper surface of the base 23 in layers at a temperature equal to or lower than the fusing point of the metal powder P to thereby particularly perform diffusion bonding to the metal powder P in interface bonding. That is, particles of the metal powders P adjacent to one another are integrated by the interface bonding. Here, the diffusion bonding includes solid-phase diffusion bonding and liquid-phase diffusion bonding.

### (1-2. Additive Manufacturing Method)

An additive manufacturing method of the shaped article W will be explained with reference to FIG. 1 and FIG. 2. The metal powder P is stored in the powder storing container 31 in a state where the supply table 32 in the powder supply device 30 is positioned in a lower part. A desired amount of metal powder P is allowed to protrude from the opening of the powder storing container 31 by lifting the supply table 32. At the same time, the base 23 is attached to the upper surface of the lifting table 22 in the shaped article support device 20, and the lifting table 22 is positioned so that the upper surface of the base 23 is positioned at a slightly lower position than the opening of the container for shaping 21. The base 23 is in a state of being heated by the temporary heating device 50.

The recoater 33 is moved from the powder supply device 30 side toward the shaped article support device 20 side while the above state is set as an initial state (Step S1). According to this, the metal powder P in the powder supply device 30 is moved to the upper surface of the base 23 and is arranged in layers with the same thickness on the upper surface of the base 23.

Subsequently, when the metal powder P is arranged on the upper surface of the base 23, the base 23 is heated by the temporary heating device 50, therefore, the metal powder P arranged in layers on the upper surface of the base 23 is heated (Step S2: temporary heating step). That is, the temporary heating device 50 heats the entire range of the metal powder P arranged in layers on the upper surface of the base 23 through the base 23. Here, a temperature of the metal powder P heated by the temporary heating device 50 through the base 23 is a temperature equal to or lower than a fusing point of the metal powder P. Therefore, the metal powder P is not fused. However, the metal powder P is integrated particularly by diffusion bonding in the interface bonding.

Furthermore, at least part of moisture adhering to the metal powder P is evaporated by heating the metal powder P arranged in layers by the temporary heating device 50. Here, the heating temperature by the temporary heating device 50 is set to a temperature equal to or lower than the fusing point of the metal powder P. Therefore, it is possible to suppress rapid evaporation of moisture as compared with a case where fusion bonding is performed without preparation. As evaporation power of moisture generated when moisture is evaporated is relatively small, scattering of the metal powder P due to the evaporation power of moisture can be suppressed.

Subsequently, the light irradiation device (main heating device) 40 irradiates the metal powder P diffusion bonded on the upper surface of the base 23 with the light beam. The light beam is scanned based on a prescribed program. Then, the light irradiation device 40 heats the metal powder P at the temperature equal to or higher than the fusing point of the metal powder P (Step S3: main heating step). That is, the diffused-bonded metal powder P is fusion bonded. The metal powder P diffusion bonded in the previous step is fused and then solidified after that. Accordingly, the position irradiated with the light beam is integrated by strong power.

Here, prior to the heating of the metal powder P by the light beam irradiation device 40, the metal powder P has been already diffusion bonded by the temporary heating device 50. The metal powder P has different thermal conductivities in the diffusion bonded state and in a not-diffusion bonded state. Here, as the metal powder P is arranged on the upper surface of the base 23, heat possessed by the metal powder P is moved toward the base 23, thereby radiating the heat of the metal powder P. Then, the diffusion-bonded metal powder P has high heat radiation performance with respect to the base 23 and the not-diffusion bonded metal powder P has low heat radiation performance with respect to the base 23.

That is, the metal powder P is diffusion bonded when the metal powder P is heated by the light beam irradiation device 40, therefore, the metal powder P has the high heat radiation performance. Accordingly, an energy density of the light beam irradiated by the light beam irradiation device 40 is set based on an amount of change in the heat radiation performance of the metal powder P changed due to the diffusion bonding. That is, the energy density of the light beam is a value obtained by adding an energy density due to the heat radiation performance of the diffusion-bonded metal powder P to an energy density necessary for performing fusion bonding of the metal powder P which is not bonded. When the energy density of the light beam is set as described above, the metal powder P can be fusion bonded positively.

Subsequently, whether all layers have been processed or not (Step S4) is determined. When all layers have not been processed (S4: No), the above processing is repeated. On the other hand, when all layers have been processed (S4: Yes), the above processing is ended and the shaped article W is completed on the upper surface of the base 23.

Here, when the light beam is irradiated by the light beam irradiation device 40, the metal powder P is fused. However, the metal powder P has been already diffusion bonded at a point before being fused. Therefore, even when the power density in the metal powder P is increased by irradiation with the light beam, it is possible to suppress evaporation of metal at a part irradiated with the light beam and scattering of spatters.

Also, the metal is evaporated and spatters may be scattered not only at a part fused by irradiation with the light beam but also at a part around the fused part. However, the entire range of the metal powder P is heated by the temporary heating device 50, and all particles of metal powders P are diffusion bonded in the present embodiment. That is, a heating range by the temporary heating device 50 is wider than the irradiation range of the light beam. Accordingly, if the power density is increased around the fused part due to irradiation with the light beam, evaporation of metal and scattering of spatters are suppressed at the part around the fused part. Therefore, the shaped article W with a desired density can be produced by previously performing diffusion bonding before performing fusion bonding with the light beam.

Furthermore, at least part of moisture adhering to the metal powder P is evaporated by the temporary heating device 50 as described above. Then, at least part of remaining moisture is evaporated also when the light beam is irradiated by the light beam irradiation device 40. Therefore, evaporation power of moisture is generated when the light beam is irradiated.

However, part of moisture has already been evaporated by the temporary heating device 50, therefore, moisture to be evaporated has already been reduced when the light beam is irradiated. Therefore, evaporation power due to moisture is suppressed when the light beam is irradiated. When the evaporation power of moisture is suppressed, scattering of the metal powder P is suppressed at the time of irradiation with the light beam. Namely, the shaped article W with a desired density can be produced also by suppressing evaporation power of moisture.

### 2. Second Embodiment

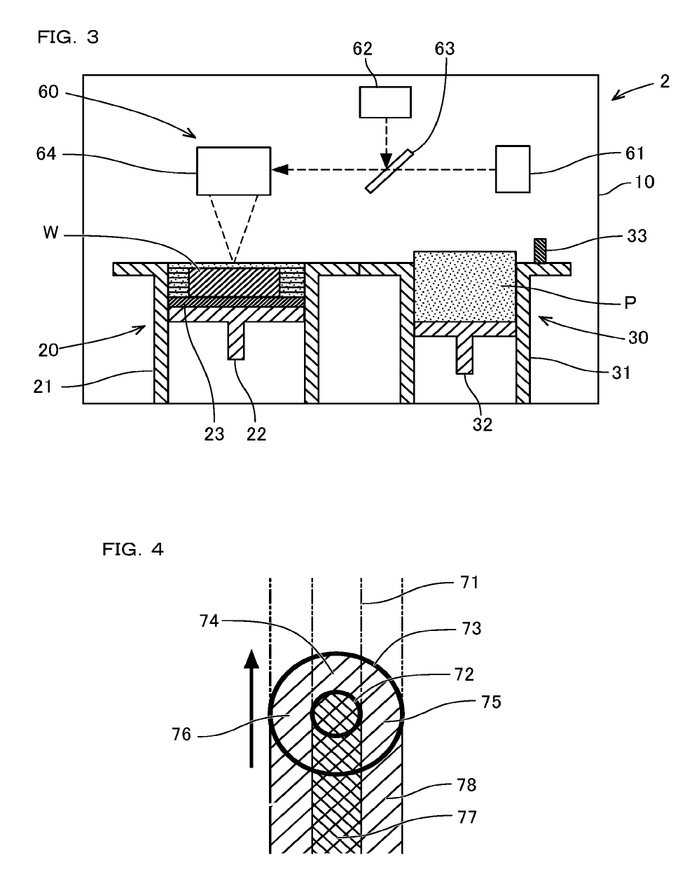

An additive manufacturing apparatus 2 according to a second embodiment will be explained with reference to FIG. 3 and FIG. 4. Concerning the additive manufacturing apparatus 2, the same symbols are given to the same components as those of the additive manufacturing apparatus 1 according to the first embodiment and explanation is omitted. The additive manufacturing apparatus 2 includes the chamber 10, the shaped article support device 20, the powder supply device 30 and a light beam irradiation device 60 (a main heating device, a temporary heating device) as shown in FIG. 3.

The light beam irradiation device 60 includes a main light beam generation device 61 forming a main heating device and generating a main light beam, a temporary light beam generation device 62 forming a temporary heating device and generating a temporary light beam, a dichroic mirror 63 superimposing the main light beam on the temporary light beam and an irradiation device 64 emitting the superimposed light beam. That is, one light beam irradiation device 60 functions as a device emitting the main light beam in the main heating step as well as functions as a device emitting the temporary light beam in a temporary heating step.

Here, a shape of a spot 72 of the main light beam and a shape of a spot 73 of the temporary light beam are concentric circles. A diameter of the spot 72 of the main light beam is smaller than a diameter of the spot 73 of the temporary light beam. That is, the main light beam is superimposed only part of the temporary light beam. A power density by the main light beam is higher than a power density by the temporary light beam. Specifically, a range in which the main light beam is irradiated is heated to a temperature equal to or higher than a fusing point of the metal powder P, and a range in which only the temporary light beam is irradiated is heated to a temperature equal to or lower than the fusing point of the metal powder P.

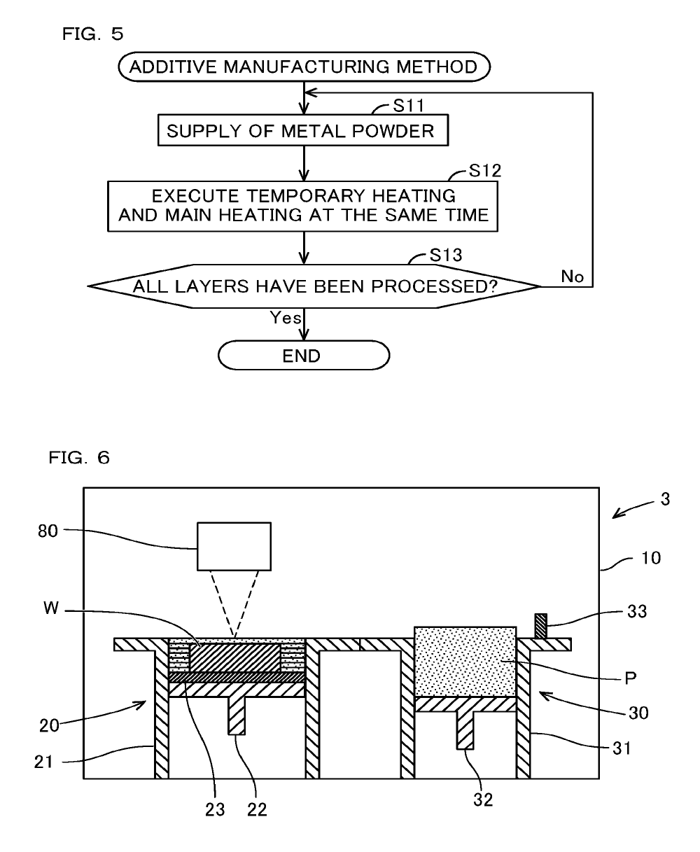

Next, an additive manufacturing method will be explained with reference to FIG. 4 and FIG. 5. The recoater 33 is moved from the powder supply device 30 side toward the shaped article support device 20 side (Step S11). Accordingly to this, the metal powder P in the powder supply device 30 is moved to the upper surface of the base 23 and is arranged in layers with the same thickness on the upper surface of the base 23.

Subsequently, the main heating is performed by scanning the main light beam along a predetermined route 71 (shown in FIG. 4) by the light beam irradiation device 60, and the temporary heating is performed by scanning the temporary light beam at the same time as the main light beam along the same route 71 as the main light beam (Step S12: temporary heating step, main heating step). That is, the main heating is performed to a range 77 corresponding to the spot 72 of the main light beam, and the temporary heating is performed to a range 78 corresponding to the spot 73 of the temporary light beam. Here, the temporary light beam is irradiated in a scanning route corresponding to the scanning route 71 of the main light beam and is not irradiated to other ranges. Therefore, the temporary light beam is irradiated to only part of the range, not to the entire range of the metal powder P arranged in layers on the upper surface of the base 23.

Subsequently, whether all layers have been processed or not (Step S13) is determined. When all layers have not been processed (S13: No), the above processing is repeated. On the other hand, when all layers have been processed (S13: Yes), the above processing is ended and the shaped article W is completed on the upper surface of the base 23.

Here, as shown in FIG. 4, the diameter of the spot 73 of the temporary light beam is larger than the diameter of the spot 72 of the main light beam, and the both spots 72 and 73 are concentric. Accordingly, when the main light beam and the temporary light beam move along the scanning route 71 at the same time, a range 74 existing ahead of the main light beam in a moving direction is irradiated with the temporary light beam. Moreover, ranges 75 and 76 on both sides of the main light beam in the moving direction are also irradiated with the temporary light beam.

Therefore, a fused part and a part around the fused part to be fused by the irradiation with the main light beam are irradiated with the temporary light beam before the irradiation by the main light beam. Accordingly, the metal powder P at the fused part and the part around the fused part to be fused by the main light beam is integrated by diffusion bonding before irradiation with the main light beam. At the same time, at least part of moisture adhering to the metal powder P at the fused part and the part around the fused part is evaporated by irradiation with the temporary light beam.

As a result, evaporation of metal and scattering of spatters at the part irradiated with the main light beam are suppressed. As evaporation power by moisture adhering to the metal powder P is suppressed, scattering of the metal powder P due to the evaporation power of moisture is suppressed. Therefore, the shaped article W with a desired density can be produced.

### 3. Third Embodiment

An additive manufacturing apparatus 3 according to a third embodiment will be explained with reference to FIG. 6 to FIG. 8. Concerning the additive manufacturing apparatus 3, the same symbols are given to the same components as those of the additive manufacturing apparatus 1 according to the first embodiment and explanation is omitted. The additive manufacturing apparatus 3 includes the chamber 10, the shaped article support device 20, the powder supply device 30 and a light beam irradiation device 80 (a main heating device, a temporary heating device) as shown in FIG. 6. The light beam irradiation device 80 can change the setting of irradiation conditions. In particular, the light beam irradiation device 80 can change the setting of a main heating condition used when the main light beam is irradiated and the setting of a temporary heating condition used when the temporary light beam is irradiated.

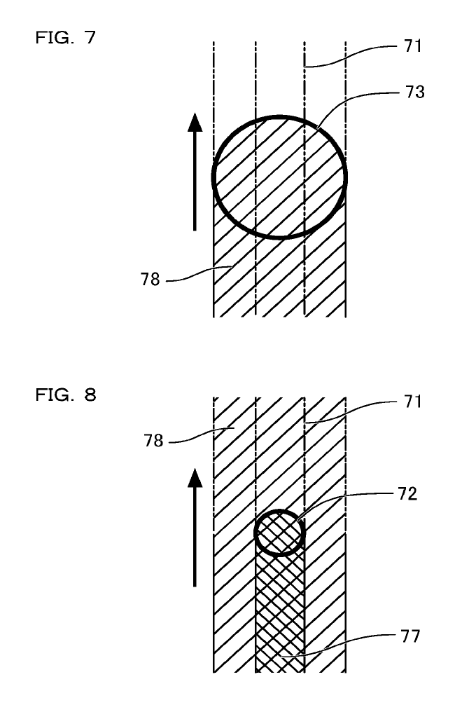

The main light beam is shown in FIG. 8 and the temporary light beam is shown in FIG. 7. As shown in FIG. 7 and FIG. 8, a shape of the spot 72 of the main light beam and a shape of the spot 73 of the temporary light beam are both a circular shape. However, a diameter of the spot 72 of the main light beam is smaller than a diameter of the spot 73 of the temporary light beam. A power density by the main light beam is higher than a power density by the temporary light beam. Specifically, a range in which the main light beam is irradiated is heated to a temperature equal to or higher than a fusing point of the metal powder P, and a range in which only the temporary light beam is irradiated is heated to a temperature equal to or lower than metal powder P.

Next, an additive manufacturing method will be explained with reference to FIG. 7 to FIG. 9. The recoater 33 is moved from the powder supply device 30 side toward the shaped article support device 20 side (Step S21). Accordingly, the metal powder P in the powder supply device 30 is moved to the upper surface of the base 23 and is arranged in layers with the same thickness on the upper surface of the base 23.

Subsequently, the light beam irradiation device 80 is set the light beam irradiation device 80 in the temporary heating condition (Step S22). That is, the light beam irradiation device 80 can perform irradiation with the temporary light beam. Then, as shown in FIG. 7, the temporary light beam is scanned by the light beam irradiation device 80 along the predetermined route 71 to thereby perform temporary heating (Step S23: temporary heating). That is, the temporary heating is performed to the range 78 corresponding to the spot 73 of the temporary light beam and the metal powder P is diffused-bonded.

Here, the scanning route 71 corresponds to a part to be formed as the shaped article W by irradiation with the main light beam. However, the diameter of the spot 73 of the temporary light beam is larger than the diameter of the spot 72 of the main light beam, therefore, a range in which diffusion bonding is performed by the temporary light beam will be a range slightly wider than the part to be formed as the shaped article W. The temporary light beam is irradiated only to part of the range, not to the entire range of the metal powder P arranged in layers on the upper surface of the base 23.

Subsequently, whether scanning of all the predetermined route 71 has been completed with the temporary light beam or not is determined (Step S24), and when all scanning has not been completed (S24: No), the temporary heating is continued. On the other hand, when all scanning has been completed (S24: Yes), the temporary heating is ended and the light beam irradiation device 80 is set in the main heating condition (Step S25). That is, the light beam irradiation device 80 can perform irradiation with the main light beam.

Then, as shown in FIG. 8, the main light beam is scanned along the predetermined route 71 by the light beam irradiation device 80 to thereby perform main heating (Step S26: main heating step). That is, the main heating is performed to the range 77 corresponding to the spot 72 of the main light beam. The main light beam is irradiated to the center in a width in which the temporary heating has been already performed. Then, the diffused-bonded metal powder P in the range in which the main light beam is irradiated is fused and then solidified after that. Accordingly, the position irradiated with the main light beam is integrated by fusion bonding.

Subsequently, whether scanning of the entire predetermined route 71 has been completed with the main light beam or not is determined (Step S27), and when all scanning has not been completed (S27: No), the main heating is continued. On the other hand, when all scanning has been completed (S27: Yes), the main heating is ended and whether all layers have been processed or not is determined (Step S28). When all layers have not been processed (S28: No), the above processing is repeated. On the other hand, all layers have been processed (S28: Yes), the above processing is ended, and the shaped article W is completed on the upper surface of the base 23.

Also in the present embodiment, the fused part and the part around the fused part to be fused by irradiation with the main light beam are irradiated with the temporary light beam before the irradiation by the main light beam. Accordingly, the metal powder P at the fused part and the part around the fused part to be fused by the main light beam is integrated by diffusion bonding before irradiation with the main light beam. At the same time, at least part of moisture adhering to the metal powder P at the fused part and the part around the fused part is evaporated by irradiation with the temporary light beam.

As a result, evaporation of metal scattering of spatters at the part irradiated with the main light beam are suppressed. As evaporation power by the moisture adhering to the metal powder P is suppressed, scattering of the metal powder P due to the evaporation power of moisture is suppressed. Therefore, the shaped article W with a desired density can be produced.

### 4. Fourth Embodiment

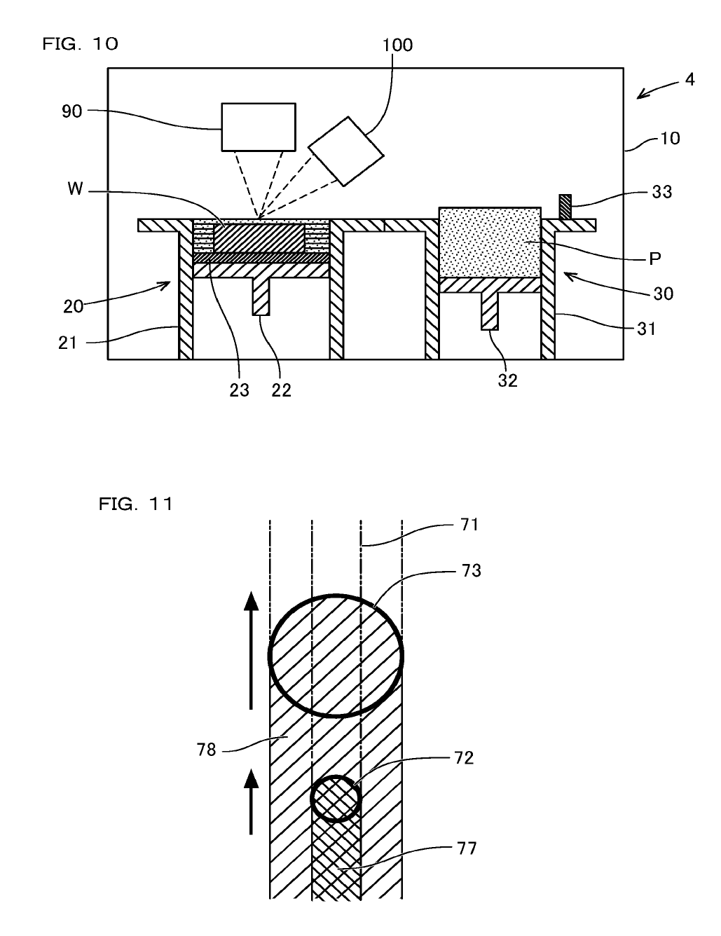

An additive manufacturing apparatus 4 according to a fourth embodiment will be explained with reference to FIG. 10 and FIG. 11. Concerning the additive manufacturing apparatus 4, the same symbols are given to the same components as those of the additive manufacturing apparatus 1 according to the first embodiment and explanation is omitted. The additive manufacturing apparatus 4 includes the chamber 10, the shaped article support device 20, the powder supply device 30, a first light beam irradiation device 90 (main heating device) and a second light beam irradiation device 100 (temporary heating device) as shown in FIG. 10. The first light beam irradiation device 90 and the second light beam irradiation device 100 are separate devices. The first light beam irradiation device 90 is set in the main heating condition in which the main light beam is irradiated. The second light beam irradiation device 100 is set in the temporary heating condition in which the temporary light beam is irradiated.

The main light beam and the temporary light beam are substantially the same as those of the third embodiment. However, the first light beam irradiation device 90 and the second light beam irradiation device 100 are separate devices in the present embodiment, therefore, the main light beam and the temporary light beam can be irradiated to different positions at the same time. Accordingly, the spot 72 of the main light beam and the spot 73 of the temporary light beam are shown in FIG. 11. As shown in FIG. 11, during irradiation with the temporary light beam performed in advance, the main light beam is irradiated while following the temporary beam in the scanning route 71 of the main light beam.

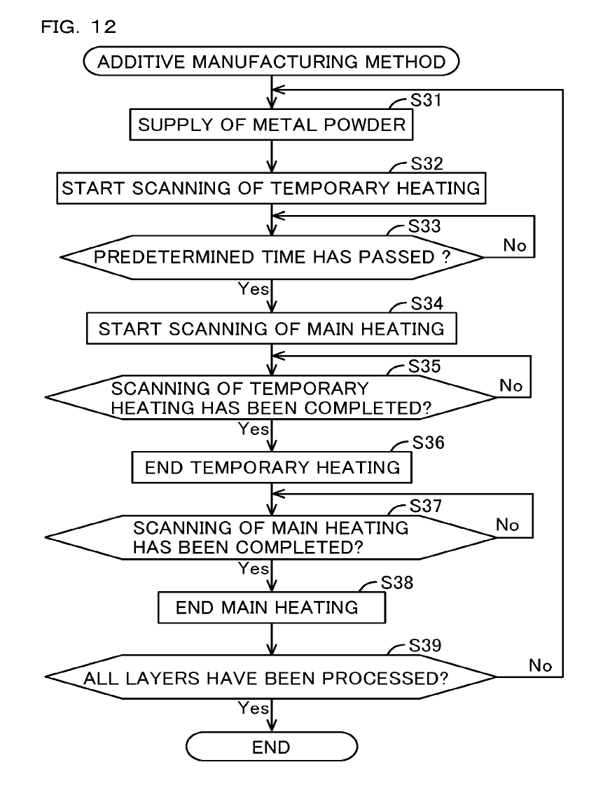

Next, an additive manufacturing method will be explained with reference to FIG. 11 and FIG. 12. The recoater 33 is moved from the powder supply device 30 side toward the shaped article support device 20 side (Step S31). Accordingly, the metal powder P in the powder supply device 30 is moved to the upper surface of the base 23 and is arranged in layers with the same thickness on the upper surface of the base 23.

Subsequently, scanning of the temporary light beam is started along the predetermined route 71 by the second light beam irradiation device 100 (Step S32: temporary heating step). That is, the temporary heating by the temporary light beam is started. As shown in FIG. 11, the temporary heating is performed to the range 78 corresponding to the spot 73 of the temporary light beam and the metal powder P is diffusion-bonded.

Subsequently, when a predetermined time passes from the start of scanning by the temporary light beam (Step S33: Yes), scanning by the main light beam is started along the predetermined route 71 by the first light beam irradiation device 90 (Step S34: main heating step). That is, the main heating by the main light beam is started. As shown in FIG. 11, the range 78 irradiated with the temporary light beam is irradiated with the main light beam following the temporary light beam. That is, the main light beam is irradiated to the center in a width in which the temporary heating has already been performed. Then, the diffused-bonded metal powder P in the range in which the main light beam is irradiated is fused and then solidified after that. Accordingly, the range in which the main light beam is irradiated (the range 77 corresponding to the spot 72 of the main light beam) is integrated by fusion bonding.

As described above, while the temporary heating with the temporary light beam is performed in advance along the scanning route 71, the main heating with the main light beam follows the temporary heating. Subsequently, whether scanning of the entire predetermined route 71 by the temporary light beam has been completed or not is determined (Step S35), and when all scanning has not been completed (Step 35: No), the temporary heating is continued. On the other hand, all scanning has been completed (S35: Yes), the temporary heating is completed (Step S36).

In the above state, the main heating by the trailing main light beam is still being performed. Then, whether scanning of the entire predetermined route 71 by the main light beam has been completed or not is determined (Step S37), and when all scanning has not been completed (Step 37: No), the main heating is continued. On the other hand, all scanning has been completed (S37: Yes), the main heating is ended (Step S38).

Subsequently, whether all layers have been processed or not (Step S39) is determined. When all layers have not been processed (S39: No), the above processing is repeated. On the other hand, all layers have been processed (S39: Yes), the above processing is ended and the shaped article W is completed on the upper surface of the base 23.

Also in the present embodiment, the fused part and the part around the fused part to be fused by irradiation with the main light beam are irradiated with the temporary light beam before the irradiation by the main light beam. Accordingly, the metal powder P at the fused part and the part around the fused part to be fused by the main light beam is integrated by diffusion bonding before irradiation with the main light beam. At the same time, at least part of moisture adhering to the metal powder P at the fused part and the part around the fused part is evaporated by irradiation with the temporary light beam.

As a result, evaporation of metal and scattering of spatters at the part irradiated with the main light beam are suppressed. As evaporation power by moisture adhering to the metal powder P is suppressed, scattering of the metal powder P due to the evaporation power of moisture is suppressed. Therefore, the shaped article W with a desired density can be produced.

### 5. Others

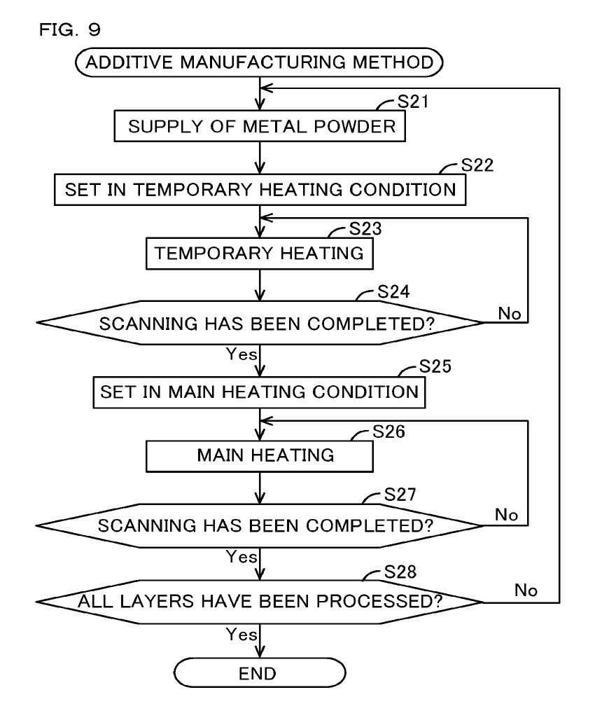

In the above respective embodiments, the metal powder P is diffusion bonded while evaporating at least part of moisture adhering to the metal powder P in the temporary heating step (S2 in FIG. 2, S12 in FIG. 5, S23 in FIGS. 9 and S32 in FIG. 12). In addition to this, it is also possible to evaporate moisture without performing diffusion bonding of the metal powder in the temporary heating step. In this case, the temporary heating device 50, the light beam irradiation device 60 functioning as the temporary heating device, the light beam irradiation device 80 functioning as the temporary heating device and the second light beam irradiation device 100 functioning as the temporary heating device evaporate moisture without performing diffusion bonding of the metal powder P.

After the temporary heating, the light irradiation device 40 functioning as the main heating device, the light irradiation device 60 functioning as the main heating device, the light irradiation device 80 functioning as the main heating device and the light irradiation device 90 functioning as the main heating device irradiate the metal powder P from which moisture adhering by the temporary heating is evaporated with the light beam, thereby forming the shaped article W. In this case, the effect by evaporating moisture in the temporary heating step can be obtained. That is, as moisture has already been reduced, the evaporation power by the moisture is suppressed at the time of the main heating. Accordingly, scattering of the metal powder P is suppressed at the time of irradiation of the light beam in the main heating step. As a result, the shaped article W with a desired density can be produced.

What is claimed is:

1. An additive manufacturing apparatus of a shaped article comprising:
a temporary heating device heating metal powder arranged in layers at a temperature equal to or lower than a fusing point of the metal powder to allow the metal powder to be diffusion bonded; and
a main heating device heating the metal powder at a temperature equal to or higher than the fusing point of the metal powder by irradiating the diffusion-bonded metal powder with a light beam to thereby form a shaped article,
wherein the temporary heating device heats a range wider than an irradiation range with the light beam by the main heating device.

2. The additive manufacturing apparatus of the shaped article according to claim 1,
wherein the temporary heating device heats the metal powder arranged in layers at the temperature equal to or lower than the fusing point of the metal powder to allow the metal powder to be diffusion bonded while evaporating at least part of moisture adhering to the metal powder.

3. The additive manufacturing apparatus of the shaped article according to claim 1, further comprising:
a base for arranging the metal powder in layers on a upper surface and for supporting the shaped article at the time of forming,
wherein the temporary heating device heats the metal powder arranged in layers on the upper surface of the base over the entire range by heating the base.

4. The additive manufacturing apparatus of the shaped article according to claim 1,
wherein the temporary heating device heats the metal powder by irradiating the metal powder with a temporary light beam in a scanning route corresponding to a scanning route of the light beam by a main heating device by using the temporary light beam having a spot diameter wider than a spot diameter of the light beam irradiated by the main heating device.

5. The additive manufacturing apparatus of the shaped article according to claim 4,
wherein the light beam by the main heating device is irradiated at the same time as the temporary light beam by the temporary heating device and is superimposed on part of the temporary light beam, and
the light beam and the temporary light beam are scanned in the same route at the same time.

6. The additive manufacturing apparatus of the shaped article according to claim 4,
wherein the main heating device is a separate device from the temporary heating device, and
the main heating device performs irradiation with the light beam while following the scanning route during irradiation with the temporary light beam performed in advance in the scanning route of the light beam.

7. The additive manufacturing apparatus of the shaped article according to claim 4,
wherein the temporary heating device and the main heating device form one light beam irradiation device, and
the temporary light beam can be irradiated as well as the light beam can be irradiated by changing irradiation conditions of the light beam irradiation device.

8. The additive manufacturing apparatus of the shaped article according to claim 1,
wherein an energy density of the light beam irradiated by the main heating device is set based on an amount of change in heat irradiation performance of the metal powder changed due to the diffusion bonding by the temporary heating device.

9. An additive manufacturing apparatus of a shaped article comprising:
a temporary heating device heating metal powder arranged in layers at a temperature equal to or lower than a fusing point of the metal powder to evaporate at least part of moisture adhering to the metal powder; and
a main heating device heating the metal powder at a temperature equal to or higher than the fusing point of the metal powder by irradiating the metal powder with a light beam after the heating by the temporary heating device to thereby form a shaped article.

10. An additive manufacturing method of a shaped article comprising the steps of:
heating metal powder arranged in layers at a temperature equal to or lower than a fusing point of the metal powder to allow the metal powder to be diffusion bonded in a temporary heating step; and
heating the metal powder at a temperature equal to or higher than the fusing point of the metal powder by irradiating the diffusion-bonded metal powder with a light beam to thereby form a shaped article in a main heating step,
wherein, in the temporary heating step, a range wider than an irradiation range with the light beam by the main heating step is heated.

11. An additive manufacturing method of a shaped article comprising the steps of:
heating metal powder arranged in layers at a temperature equal to or lower than a fusing point of the metal powder to evaporate at least part of moisture adhering to the metal powder in a temporary heating step; and
heating the metal powder at a temperature equal to or higher than the fusing point of the metal powder by irradiating the metal powder with a light beam after the heating in the temporary heating step to thereby form a shaped article in a main heating step.
